(19) United States
(12) Patent Application Publication
(10) Pub. No.: US 2013/0209612 A1
(43) Pub. Date: Aug. 15, 2013

(54) USE OF A MIXTURE OF PROBIOTIC BACTERIA IN A MIXTURE WITH SHORT-CHAIN FATTY ACIDS

(71) Applicants: Pawel MICHALOWSKI, Michalow Grabina (PL); Adam KICIAK, Warszawa (PL)

(72) Inventors: Pawel MICHALOWSKI, Michalow Grabina (PL); Adam KICIAK, Warszawa (PL)

(21) Appl. No.: 13/750,285

(22) Filed: Jan. 25, 2013

Related U.S. Application Data
(63) Continuation-in-part of application No. PCT/PL2011/050027, filed on Jul. 19, 2011.

(30) Foreign Application Priority Data
Jul. 28, 2010 (PL) P.391985

(51) Int. Cl. A23L 1/30

(52) U.S. Cl. CPC A23L 1/3014
USPC 426/61

(57) ABSTRACT

A use of a mixture of probiotic bacteria in a mixture with short-chain fatty acids. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/PL2011/050027, filed on Jul. 19, 2011, which claims priority from Poland Patent Application No. P.391985, filed on Jul. 28, 2010. International Patent Application No. PCT/PL2011/050027 was pending as of the filing date of this application. The United States was an elected state in International Patent Application No. PCT/PL2011/050027.

### BACKGROUND

1. Technical Field

The present application relates to use of a mixture of probiotic bacteria in a mixture with short-chain fatty acids.

2. Background Information

Background information is for informational purposes only and does not necessarily admit that subsequently mentioned information and publications are prior art.

Some disruptions in the functioning of the gastrointestinal tract, including those caused by dietary changes, are made evident by diarrhea and/or increased gas production (ammonia, hydrogen sulphide and derivatives), which causes distention, abdominal discomfort and pain of varying intensity. These are usually based on acid-base disequilibria in the individual sections of the gastrointestinal tract, which damages the gastrointestinal epithelium and shifts the intestinal bacterial flora towards pathogenic and/or facultatively pathogenic species.

Deleterious pH shifts in the gastrointestinal lumen are usually directly connected with disruptions of the integrity of the gastric and intestinal mucosa. The ability of the stomach, duodenum and the entire lower gastrointestinal tract to remain undamaged in an environment comprising digestive juices as well as the capability of reacting to damage is dependent on physiological equilibrium between aggressive factors in the gastrointestinal lumen and defensive and regenerative mechanisms of the mucosa. Mucous membrane defensive factors include: carbonate and mucus secretion, prostaglandin production, epithelial hydrophobicity essentially ensured or promoted by mucus proteins, as well as maintaining adequate blood flow in the mucous membrane. Regenerative mechanisms comprise repair, regeneration and typical healing processes. Conditional to the activation of these mechanisms is the maintenance of the basal membrane of the epithelium. When this is damaged, the disease develops and clinical symptoms appear. Similar changes occur following antibiotic, chemo- and radiotherapy, during which the mucosa are damaged or destroyed and the bacterial equilibrium is disrupted. Reinstitution of the healthy structure of mucosal cells, as well as the proper composition and density of bacterial flora is essential to convalescence and healing.

To date, there are no preparations composed of a mixture of live bacterial cultures with organic acids and/or salts thereof, which would be capable of significantly affecting the maintenance and modification of proper bacterial flora and pH of the lower gastrointestinal tract. For this purpose, it was common to use probiotics comprising mixtures of various strains, mainly LAB. However, the chronic use of these often exerts a negative impact on the composition and functioning of the bacterial flora of the gastrointestinal tract. The activity of probiotic preparations is dependent on whether, and what kind of medicinal products are taken in parallel or in combination with them.

### OBJECT OR OBJECTS

The subject of the present application is the use of a mixture of probiotic bacteria in a mixture with short chain fatty acids (SCFA), in a form that slowly releases active substances with varying structure and release mechanisms, in the diet of monogastric animals, for example the human diet, in order to modulate intestinal bacterial flora and to improve the acid-base and water-electrolyte management of the gastrointestinal tract, in the manufacturing a preparation for maintaining the bacterial and acid-base bacterial and acid-base homeostasis of the distal portion of the gastrointestinal tract of monogastric animals, including the human small intestine and colon.

### SUMMARY

Use of a mixture of probiotic bacteria with protected short chain fatty acids and/or salts thereof selected from among fumaric acid, citric acid, malic acid, sorbic acid and sodium butyrate in the manufacturing of a preparation for maintaining the bacterial and acid-base homeostasis of the distal portion of the gastrointestinal tract of monogastric animals, including the human small intestine and colon.

In at least one possible embodiment, the use according to the present application may comprise the manufacturing of the preparation use is additionally made of live bacterial cultures selected from among probiotic bacteria of a function as well as active ingredients that affect the stability of the pH of the distal portion of the gastrointestinal tract, that exhibit bacteriocidal properties against pathogenic and facultatively pathogenic bacteria, and affect the intestinal mucosa and, by the same token, the proliferation and settlement of probiotic bacteria on intestinal walls.

In another possible embodiment, the use according to the present application in which the preparation produced comprises a mixture of live, selected probiotic bacteria: Lactobacillus rhamnosus GG, Bifidobacterium and Streptococcus thermophilus at 1×10⁹ CFU/g, fumaric acid in the amount of 100 ring/g, citric acid in the amount of 60 mg/g, malic acid in the amount of 40 mg/g, sorbic acid in the amount of 50 mg/g, triglyceride matrix in the amount of 250 mg/g as well as ancillary substances to 1 g.

In at least one possible embodiment, a use according to the present application in which the preparation produced is in the form of hard cellulose or gelatine capsules with a net weight of 500 mg.

Another embodiment according to the present application is a preparation which makes it possible to restore proper microbiological equilibrium as well as regulating the pH of intestinal contents, with the concurrent nourishment of intestinal mucosal cells, which essentially ensures or promotes the proper functioning of the distal portions of the gastrointestinal tract, maintains the microbiological and acid-base equilibrium of the gastrointestinal tract, in which the preparation comprises live bacteria: Lactobacillus rhamnosus GG, Bifidobacterium and Streptococcus thermophilus, as well as fumaric acid, citric acid, malic acid, and sorbic acid in a triglyceride matrix.

In at least one possible embodiment, a preparation according to the present application wherein it comprises Lactobacillus rhamnosus GG, Bifidobacterium and Streptococcus thermophilus at 2×10⁹ CFU/g, fumaric acid in the amount of 100 mg/g, citric acid in the amount of 60 mg/g, malic acid in the amount of 40 mg/g, sorbic acid in the amount of 50 mg/g, triglyceride matrix in the amount of 250 mg/g and ancillary substances.

In at least one possible embodiment, a preparation according to the present application wherein the preparation is in the form of hard cellulose or gelatine capsules weighing 500 mg.

According to another embodiment the present application relates to the use of a mixture of live bacterial cultures of Lactobacillus rhamnosus GG, Bifidobacterium and Streptococcus thermophilus and short chained fatty acids in a form slowly released in the human intestines, in a diet for humans in order to modulate bacterial flora, to and to modulate the pH of intestinal contents and water balance.

According to one possible embodiment, the present application relates to the use of a mixture of live bacterial cultures of Lactobacillus rhamnosus GG, Bifidobacterium and Streptococcus thermophilus as well as short-chained fatty acids protected in the triglyceride matrix that slowly releases the active ingredients comprised therein into the gastrointestinal tract, in the nutrition of mono-gastric animals in order to modulate bacterial flora, the pH of gastrointestinal contents and water balance.

According to another possible embodiment, the present application relates to the use of a preparation comprising a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, for example, a mixture of live bacterial cultures of Lactobacillus rhamnosus GG, Bifidobacterium and Streptococcus thermophilus at a total density of 2 to 4×10⁹ CFU, fumaric acid in the amount of 100 to 150 mg/g and/or citric acid in the amount of 60 to 120 mg/g and/or malic acid in the amount of 40 to 80 mg/g, and/or sorbic acid in the amount of 50 to 100 mg/g and triglyceride matrix in the amount of 200-300 mg/g as well as ancillary substances up to 1 g, in one possible embodiment a mixture of live bacterial cultures of Lactobacillus rhamnosus GG, Bifidobacterium and Streptococcus thermophilus at a density of 2×10⁹ CFU/g fumaric acid in the amount of 100 mg/g, and citric acid in the amount of 60 mg/g, and malic acid in the amount of 40 mg/g, and sorbic acid in the amount of 50 mg/g, triglyceride matrix in the amount of 250 mg as well as ancillary substances to 1 g.

In at least one possible embodiment of the present application, a preparation comprising a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, may be administered orally divided into doses, following a meal.

In at least one possible embodiment of the present application, a preparation comprising a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, may be administered orally as a supporting treatment in humans to maintain the bacterial and acid-base homeostasis the gastrointestinal tract, including the barrier function of the distal portion of the gastrointestinal tract against bacteria and fungi introduced along with food.

In at least one possible embodiment of the present application, a preparation comprising a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, may be administered orally, for example in persons acutely or chronically taking preparations that affect the pH of the distal portion of the gastrointestinal tract.

In at least one possible embodiment of the present application, a preparation comprising a mixture of live bacterial cultures of Lactobacillus rhamnosus GG, Bifidobacterium and Streptococcus thermophilus, as well as fumaric acid and/or citric acid and/or malic acid and/or sorbic acid in a triglyceride matrix, may be administered prophylactically in persons, who have moved to a different climate zone, for example a tropical or sub-tropical zone.

In at least one possible embodiment of the present application, the above product may be packed into hard cellulose capsules, with a net weight of 500 mg.

In at least one possible embodiment of the present application, the above product may be used following a meal at a rate of 1-2 capsules thrice daily.

In at least one possible embodiment of the present application, select cultures of probiotic bacteria may be used in the manufacturing of the preparation, which affect the pH of the distal portion of the gastrointestinal tract, for example for those that increase immunity and resistance of the host organism, as well as when the manufacturing of such a preparation additionally makes use of active ingredients that affect intestinal pH, in one possible embodiment those that constitute an important energy source for intestinal mucosal cells, as well as if the manufacturing additionally makes use of active ingredients that affect intestinal pH, in one possible embodiment those that accelerate the regeneration of intestinal mucosal cells, as well as if the manufacturing of such a preparation additionally makes use of active ingredients that affect the bacterial flora of the small intestine and colon, in one possible embodiment those that restore the proper intestinal function.

According to the present application, such use facilitates the restoration and maintenance of bacterial and acid-base homeostasis of the distal portion of the gastrointestinal tract. A mixture of live bacterial cultures of Lactobacillus rhamnosus GG, Bifidobacterium and Streptococcus thermophilus and short-chained fatty acids or their salts in a triglyceride matrix (a form in which they significantly affect the development of probiotic bacteria), at the same time acting as a bactericide towards pathogenic and facultatively pathogenic bacteria, improving the condition of intestinal mucosal cells, facilitates the maintenance of the proper microbiological equilibrium of the gastrointestinal tract, at the same time affecting the maintenance of the acid-base equilibrium.

A significant feature of the present application is the simultaneous or substantially simultaneous use of live cultures of probiotic bacteria and protected short-chained fatty acids, the use of the unexpected synergism of live bacterial cultures and protected fatty acids, which increased the activity of such a mixture to an unexpected degree in relation to its each individual component.

Unexpectedly, it turned out possible to use a mixture live bacterial cultures of and protected short-chained fatty acids or their salts, which in this form modify the pH of gastrointestinal contents while simultaneously or substantially simultaneously modulating the bacterial flora and improving (normalizing) the water balance to restore the bacterial and acid-base homeostasis the gastrointestinal tract.

Unexpectedly, it also turned out to compose such a composition of mixture live bacterial cultures with SCFA of natural origin and such a mixture of bacterial cultures of a predefined density as well as such mutual interrelationships between them and doses of protected fatty acids, which after the application of active ingredient release control techniques can significantly affect the settlement and proliferation of probiotic bacteria (introduced and already extant in the gastrointestinal tract), attainment of the correct pH of intestinal contents as well as making use of their bacteriocidal and bacteriostatic properties and which also supplies energy to cells of the intestinal mucosa.

One of the conditions for the safe use of the product was the selection of SCFA occurring in natural as well as appropriately selected bacterial strains.

The matrix was composed such that the release period of the substances comprised therein was equal to the average total passage time of nutrients through the gastrointestinal tract of a healthy human.

Unexpectedly, it turned out, the mixture of live bacterial cultures of Lactobacillus rhamnosus GG, Bifidobacterium and Streptococcus thermophilus and short chain fatty acids in form slowly released in the human gastrointestinal tract, including those protected in a triglyceride matrix, according to the present application, may be used in human and monogastric animal nutrition. Example embodiment of the present application. Manufacturing of the product for use in humans, comprising the live cultures of Lactobacillus rhamnosus GG, Bifidobacterium and Streptococcus thermophilus, as well as fumaric acid, citric acid, malic acid, sorbic acid in a triglyceride matrix, in cellulose or gelatine capsules.

In a homogenizer, Lactobacillus rhamnosus GG, Bifidobacterium and Streptococcus thermophilus supplemented with ancillary substances are mixed to obtain the required and/or desired product consistency. After homogenization, the product is packed into containers specially prepared for this purpose, from which samples are taken for analysis.

The powder thus produced, comprising live bacterial cultures and meeting quality requirements, together with a separately produced microgranulate comprising normalized quantities of fumaric acid, citric acid, D-L-malic acid and sorbic acid in a triglyceride matrix, is then sent for encapsulation in two sections of the same encapsulating machine. The first section loads the capsule with a predefined quantity of powder of a microbiological density, whereas the second section (adapted for pellets and granulates) tops up the capsule with an appropriate quantity of microgranulate comprising protected organic acids. Thusly filled capsules are then sent for analysis, and then (depending on the size of packaging) packaged in blisters and placed in carton units or packaged in PE containers.

### EXAMPLES

In the experiment we used 12 pigs of the Polish White breed (Local Ethics Committee permit application No. 25/2002, Opinion No. 24/2002, 26.06.2002) weaned on the 28th day of life and maintained for 6 days on a commercial adaptation starter diet fed ad libitum. Next, each pig was given an intramuscular injection of Ijpopolysaccharide (LPS from Escherichia coli 026:B6, Sigma, St. Louis, Mo.) at a rate of 150 mg/kg body mass. The LPS was diluted in physiological saline at a concentration of 1.5 mg/ml. Over a period of <12 hours, clinical symptoms of diarrhea were noted in all of the animals. Next, the pigs were divided into three equal groups:

A—the pigs were given a preparation in cellulose capsules, which had the following composition: live bacterial cultures of Lactobacillus rhamnosus GG, Bifidobacterium and Streptococcus thermophilus at 1×10⁹ CFU/g, fumaric acid in the amount of 100 mg/g, citric acid in the amount of 60 mg/g, malic acid in the amount of 40 mg/g, sorbic acid in the amount of 50 mg/g, as well as typical ancillary substances to 1 g, embedded in a triglyceride matrix (250 mg/g), at a dose of 2×1 capsules daily.
B—the pigs were given a preparation in cellulose capsules, which had the following composition: live bacterial cultures of Lactobacillus rhamnosus GG, Bifidobacterium and Streptococcus thermophilus at 1×10⁹ CFU/g as well as typical ancillary substances to 1 g, at a dose of 2×1 capsules daily.
C—the pigs were given a preparation in cellulose capsules, which had the following composition: typical ancillary substances, at a dose of 2×1 capsules daily.

At the same time, in all groups, we continued the administration of commercial feed. In all of the animals of group A, we observed the remission of all signs of diarrhea in <48 hours. Similar effects were not observed in any of the animals of groups B and C. After 48 hours, in animals from groups B and C we initiated additional, typical veterinary procedures required and/or desired for the treatment of diarrhea.

Use of a mixture live cultures probiotic bacteria in a mixture with short chained fatty acids (SCFA), in a slow release form for the active ingredients, of various release structures and mechanisms, in one possible embodiment in the form of a triglyceride matrix; in the diet of monogastric animals, in one possible embodiment a human diet, for modulating intestinal bacterial flora as well as improving the acid-base and water-electrolyte balance of the gastrointestinal tract; in the manufacturing of a preparation for maintaining bacterial and acid-base homeostasis of the distal portion of the gastrointestinal tract of monogastric animals, including the human small intestine and colon.

One feature or aspect of an embodiment is believed at the time of the filing of this patent application to possibly reside broadly in a use of a mixture live cultures probiotic bacteria in a mixture with short chained fatty acids (SOFA), in a slow release form for the active ingredients, of various release structures and mechanisms, in one possible embodiment in the form of a triglyceride matrix; in the diet of monogastric animals, in one possible embodiment a human diet, for modulating intestinal bacterial flora as well as improving the acid-base and water-electrolyte balance of the gastrointestinal tract; in the manufacturing of a preparation for maintaining bacterial and acid-base homeostasis of the distal portion of the gastrointestinal tract of monogastric animals, including the human small intestine and colon.

Another feature or aspect of an embodiment is believed at the time of the filing of this patent application to possibly reside broadly in the use of a mixture of probiotic bacteria with protected short chained fatty acids and/or salts thereof selected from among fumaric acid, citric acid, malic acid, sorbic acid and sodium butyrate in the manufacturing of a preparation for maintaining bacterial and acid-base homeostasis of the distal portion of the gastrointestinal tract of monogastric animals, including the human small intestine and colon.

Yet another feature or aspect of an embodiment is believed at the time of the filing of this patent application to possibly reside broadly in the use, wherein in the manufacturing of the preparation, additional use is made of selected probiotic bacteria with defined functions, as well as active ingredients that affect the pH stability of the distal portion of the gastrointestinal tract, which exhibit bactericidal and bacteriostatic activity against pathogenic and facultatively pathogenic bacteria, that affect the state of intestinal mucosa and, by the same token, the proliferation and settlement of the intestinal wall by probiotic bacteria.

Still another feature or aspect of an embodiment is believed at the time of the filing of this patent application to possibly reside broadly in the use, wherein the preparation produced comprises a mixture of live, selected probiotic bacteria: Lactobacillus rhamnosus GG, Bifidobacterium and Streptococcus thermophilus at 1×10⁹ CFU/g; fumaric acid in the amount of 100 mg/g, citric acid in the amount of 60 mg/g, malic acid in the amount of 40 mg/g, sorbic acid in the amount of 50 mg/g, triglyceride matrix in the amount of 250 mg/g as well as ancillary substances up to 1 g.

A further feature or aspect of an embodiment is believed at the time of the filing of this patent application to possibly reside broadly in the use, wherein the preparation produced is in the form of hard cellulose or gelatine capsules with a net weight of 500 mg.

Another feature or aspect of an embodiment is believed at the time of the filing of this patent application to possibly reside broadly in a preparation that facilitates the restoration of an appropriate microbiological equilibrium as well as regulating the pH of intestinal contents, and which concurrently nourishes the cells of the intestinal mucosa, which essentially ensures and/or promotes the proper functioning of the distal portion of the gastrointestinal tract, maintains the microbiological and acid-base equilibrium of the gastrointestinal tract wherein it comprises live bacteria: Lactobacillus rhamnosus GG, Bifidobacterium and Streptococcus thermophilus, as well as fumaric acid, citric acid, malic acid, and sorbic acid in a triglyceride matrix.

Yet another feature or aspect of an embodiment is believed at the time of the filing of this patent application to possibly reside broadly in the preparation wherein it comprises Lactobacillus rhamnosus GG, Bifidobacterium and Streptococcus thermophilus at 2×10⁹ CFU/g, fumaric acid in the amount of 100 mg/g, citric acid in the amount of 60 mg/g, malic acid in the amount of 40 mg/g, sorbic acid in the amount of 50 mg/g, triglyceride matrix in the amount of 250 mg/g and ancillary substances.

Still another feature or aspect of an embodiment is believed at the time of the filing of this patent application to possibly reside broadly in the preparation wherein the preparation is in the form of hard cellulose or gelatine capsules with a mass of 500 mg.

A further feature or aspect of an embodiment is believed at the time of the filing of this patent application to possibly reside broadly in a use of a mixture of live bacterial cultures of Lactobacillus rhamnosus GG, Bifidobacterium and Streptococcus thermophilus as well as short-chained fatty acids protected in a triglyceride matrix that slowly releases the active ingredients comprised therein into the gastrointestinal tract, in the feeding of monogastric animals for the modulation of: bacterial flora, the pH of intestinal contents and water balance.

Another feature or aspect of an embodiment is believed at the time of the filing of this patent application to possibly reside broadly in a use of a preparation comprising a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, for example, a mixture of live bacterial cultures of Lactobacillus rhamnosus GG, Bifidobacterium and Streptococcus thermophilus at a total density of 2 to 4×10⁹ CFU, fumaric acid in the amount of 100 to 150 mg/g and/or 60 to 120 mg/g and/or malic acid in the amount of 40 to 80 mg/g, and/or sorbic acid in the amount of 50 to 100 mg/g and a triglyceride matrix in the amount of 200-300 mg/g as well as ancillary substances up to 1 g, in one possible embodiment a mixture of live bacterial cultures of Lactobacillus rhamnosus GG, Bifidobacterium and Streptococcus thermophilus at a density of 2×10⁹ CFU/g, fumaric acid in the amount of 100 mg/g, and citric acid in the amount of 60 mg/g, and malic acid in the amount of 40 mg/g, and sorbic acid in the amount of 50 mg/g, triglyceride matrix in the amount of 250 mg as well as ancillary substances to 1 g.

Yet another feature or aspect of an embodiment is believed at the time of the filing of this patent application to possibly reside broadly in the preparation comprising a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, which is post prandially administered orally, divided into doses.

Still another feature or aspect of an embodiment is believed at the time of the filing of this patent application to possibly reside broadly in the preparation comprising a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, which is administered orally as a supplement in humans in order to maintain bacterial and acid-base homeostasis the gastrointestinal tract, including the barrier function of the distal portion of the gastrointestinal tract against bacteria and fungi introduced with food.

A further feature or aspect of an embodiment is believed at the time of the filing of this patent application to possibly reside broadly in the preparation comprising a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, which is administered orally, in one possible embodiment in persons who acutely or chronically take preparations that affect the pH of the distal portion of the gastrointestinal tract.

One feature or aspect of an embodiment is believed at the time of the filing of this patent application to possibly reside broadly in the preparation comprising a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, which is administered prophylactically in persons who have moved to a new climatic zone, in one possible embodiment a tropical and subtropical zone.

Another feature or aspect of an embodiment is believed at the time of the filing of this patent application to possibly reside broadly in a preparation for maintaining bacterial and acid-base homeostasis the gastrointestinal tract of monogastric organisms, including humans, wherein the preparation comprises live, selected bacterial cultures of Lactobacillus rhamnosus GG, Bifidobacterium and Streptococcus Thermophilus, as well as a mixture of acids: fumaric acid, citric acid, D,L-malic acid and sorbic acid in a triglyceride matrix as well as ancillary substances.

Yet another feature or aspect of an embodiment is believed at the time of the filing of this patent application to possibly reside broadly in the preparation wherein the preparation comprises live bacterial cultures of Lactobacillus rhamnosus GG, Bifidobacterium and Streptococcus thermophilus at 2×10⁹ CFU/g, fumaric acid w i/ości 100 mg/g, citric acid in the amount of 60 mg/g, malic acid in the amount of 40 mg/g, sorbic acid in the amount of 50 mg/g, triglyceride matrix in the amount of 250 mg/g and ancillary substances to 1 g.

Still another feature or aspect of an embodiment is believed at the time of the filing of this patent application to possibly reside broadly in the preparation wherein it is meant for prophylactic oral administration in doses of 500 mg to 1000 mg thrice daily, in one possible embodiment, during meals.

A further feature or aspect of an embodiment is believed at the time of the filing of this patent application to possibly reside broadly in the preparation wherein 1-2 capsule thrice daily are used post prandum.

Another feature or aspect of an embodiment is believed at the time of the filing of this patent application to possibly reside broadly in the use wherein in the manufacturing of the preparation additionally makes use of selected cultures of probiotic bacteria that affect the pH of the distal portion of the gastrointestinal tract, in one possible embodiment increasing the immunity and resistance of the host organism.

Yet another feature or aspect of an embodiment is believed at the time of the filing of this patent application to possibly reside broadly in the use, wherein in the manufacturing of the preparation additionally makes use of active ingredients that affect the intestinal pH, in one possible embodiment ones that constitute an energy source for cells of the intestinal mucosa.

Still another feature or aspect of an embodiment is believed at the time of the filing of this patent application to possibly reside broadly in the use, wherein in the manufacturing of the preparation additionally makes use of active ingredients that affect the intestinal pH, in one possible embodiment ones that accelerate the regeneration of the cells of the intestinal mucosa.

A further feature or aspect of an embodiment is believed at the time of the filing of this patent application to possibly reside broadly in the use, wherein in the manufacturing of the preparation additionally makes use of active ingredients that affect the bacterial flora of the small intestine and colon, in one possible embodiment ones that restore the proper functioning of the intestines.

The components disclosed in the patents, patent applications, patent publications, and other documents disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, patent applications, patent publications, and other documents either incorporated by reference or not incorporated by reference.

All of the patents, patent applications, patent publications, and other documents, except for the exceptions indicated herein, which were cited in the International Search Report dated Dec. 6, 2011, and/or cited elsewhere, as well as the International Search Report document itself, are hereby incorporated by reference as if set forth in their entirety herein except for the exceptions indicated herein, as follows: EP 0 482 530, having the English translation of the German title “Composition for the regulation of intestinal flora,” published on Apr. 29, 1992; JP 1 098446, having the English translation of the Japanese title “FEED COMPOSITION FOR DOMESTIC ANIMAL AND FOWL,” published on Apr. 17, 1989; JP 2000 327569, having the English translation of the Japanese title “INTRAINTESTINAL ENVIRONMENT AMELIORATOR,” published on Nov. 28, 2000; U.S. 2010/159073, having the title “Protein Gelatinous Food and its Manufacture Process,” published on Jun. 24, 2010; CN 101 558 786, having the title English translation of the Chinese title “Method for preparing active probiotic beverage and product thereof,” published on Oct. 21, 2009; and CN 101 773 221, having the English translation of the Chinese title “Synbiotics fruit jelly and production method thereof,” and published on Jul. 14, 2010.

The corresponding foreign and international patent publication applications, namely, Poland Patent Application No. P.391985, filed on Jul. 28, 2010, having inventors Pawel MICHALOWSKI and Adam KICIAK, and International Application No. PCT/PL2011/050027, filed on Jul. 19, 2011, having WIPO Publication No. WO 2012/015323, having inventors Pawel MICHALOWSKI and Adam KICIAK, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in Poland and elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

The purpose of incorporating the corresponding foreign equivalent patent application(s), that is, PCT/PL2011/050027 and Poland Patent Application P.391985, is solely for the purposes of providing a basis of correction of any wording in the pages of the present application, which may have been mistranslated or misinterpreted by the translator, and to provide additional information relating to technical features of one or more embodiments, which information may not be completely disclosed in the wording in the pages of this application.

Statements made in the original foreign patent applications PCT/PL2011/050027 and P.391985 from which this patent application claims priority which do not have to do with the correction of the translation in this patent application are not to be included in this patent application in the incorporation by reference.

Any statements about admissions of prior art in the original foreign patent applications PCT/PL2011/050027 and P.391985 are not to be included in this patent application in the incorporation by reference, since the laws relating to prior art in non-U.S. Patent Offices and courts may be substantially different from the Patent Laws of the United States.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the embodiments therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more embodiments of the patents, patent applications, patent publications, and other documents, are not considered to be incorporated by reference herein for any of the patents, patent applications, patent publications, and other documents cited herein.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

1. Use of a mixture live cultures probiotic bacteria in a mixture with short chained fatty acids (SOFA), in a slow release form for the active ingredients, of various release structures and mechanisms, in particular in the form of a triglyceride matrix; in the diet of monogastric animals, in particular a human diet, for modulating intestinal bacterial flora as well as improving the acid-base and water-electrolyte balance of the gastrointestinal tract; in the manufacturing of a preparation for maintaining bacterial and acid-base homeostasis of the distal portion of the gastrointestinal tract of monogastric animals, including the human small intestine and colon.

2. The use of a mixture of probiotic bacteria with protected short chained fatty acids and/or salts thereof selected from among fumaric acid, citric acid, malic acid, sorbic acid and sodium butyrate in the manufacturing of a preparation for maintaining bacterial and acid-base homeostasis of the distal portion of the gastrointestinal tract of monogastric animals, including the human small intestine and colon.

3. A use according to claim 1, characterized in that in the manufacturing of the preparation, additional use is made of selected probiotic bacteria with defined functions, as well as active ingredients that affect the pH stability of the distal portion of the gastrointestinal tract, which exhibit bactericidal and bacteriostatic activity against pathogenic and facultatively pathogenic bacteria, that affect the state of intestinal mucosa and, by the same token, the proliferation and settlement of the intestinal wall by probiotic bacteria.

4. A use according to claim 1, characterized in that the preparation produced contains a mixture of live, selected probiotic bacteria: Lactobacillus rhamnosus GG, Bifidobacterium and Streptococcus thermophilus at 1×10⁹ CFU/g; fumaric acid in the amount of 100 mg/g, citric acid in the amount of 60 mg/g, malic acid in the amount of 40 mg/g, sorbic acid in the amount of 50 mg/g, triglyceride matrix in the amount of 250 mg/g as well as ancillary substances up to 1 g.

5. A use according to claim 1, characterized in that the preparation produced is in the form of hard cellulose or gelatine capsules with a net weight of 500 mg.

6. A preparation that facilitates the restoration of an appropriate microbiological equilibrium as well as regulating the pH of intestinal contents, and which concurrently nourishes the cells of the intestinal mucosa, which ensures the proper functioning of the distal portion of the gastrointestinal tract, maintains the microbiological and acid-base equilibrium of the gastrointestinal tract characterized in that it contains live bacteria: Lactobacillus rhamnosus GG, Bifidobacterium and Streptococcus thermophilus, as well as fumaric acid, citric acid, malic acid, and sorbic acid in a triglyceride matrix.

7. A preparation according to claim 6 characterized in that it contains Lactobacillus rhamnosus GG, Bifidobacterium and Streptococcus thermophilus at 2×10⁹ CFU/g, fumaric acid in the amount of 100 mg/g, citric acid in the amount of 60 mg/g, malic acid in the amount of 40 mg/g, sorbic acid in the amount of 50 mg/g, triglyceride matrix in the amount of 250 mg/g and ancillary substances.

8. A preparation according to claim 7 characterized in that is in the form of hard cellulose or gelatine capsules with a mass of 500 mg.

9-10. (canceled)

11. A preparation containing a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, according to claim 8, which is post prandially administered orally, divided into doses.

12. A preparation containing a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, according to claim 8, which is administered orally as a supplement in humans in order to maintain bacterial and acid-base homeostasis the gastrointestinal tract, including the barrier function of the distal portion of the gastrointestinal tract against bacteria and fungi introduced with food.

13. A preparation containing a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, according to claim 8, which is administered orally, in particular in persons who acutely or chronically take preparations that affect the pH of the distal portion of the gastrointestinal tract.

14. A preparation containing a mixture of live bacterial cultures of Lactobacillus rhamnosus GG, Bifidobacterium and Streptococcus thermophilus as well as fumaric acid and/or citric acid and/or malic acid and/or sorbic acid in a triglyceride matrix, according to claim 8, which is administered prophylactically in persons who have moved to a new climatic zone, in particular a tropical and subtropical zone.

15-16. (canceled)

17. A preparation according to claim 8, characterized in that it is meant for prophylactic oral administration in doses of 500 mg to 1000 mg thrice daily, preferentially, during meals.

18. A preparation according to claim 8 characterized in that 1-2 capsule thrice daily are used post prandum.

19. A use according to claim 1, characterized in that in the manufacturing of the preparation additionally makes use of selected cultures of probiotic bacteria that affect the pH of the distal portion of the gastrointestinal tract, in particular increasing the immunity and resistance of the host organism.

20. A use according to claim 1, characterized in that in the manufacturing of the preparation additionally makes use of active ingredients that affect the intestinal pH, particularly ones that constitute an energy source for cells of the intestinal mucosa.

21. A use according to claim 1, characterized in that in the manufacturing of the preparation additionally makes use of active ingredients that affect the intestinal pH, particularly ones that accelerate the regeneration of the cells of the intestinal mucosa.

22. A use according to claim 1, characterized in that in the manufacturing of the preparation additionally makes use of active ingredients that affect the bacterial flora of the small intestine and colon, particularly ones that restore the proper functioning of the intestines.
